(19) United States
(12) Patent Application Publication
(10) Pub. No.: US 2013/0344256 A1
(43) Pub. Date: Dec. 26, 2013

(54) SPARK DETECTION IN COATING INSTALLATIONS

(71) Applicant: Arno Moosbrugger, Hard (AT)

(72) Inventor: Arno Moosbrugger, Hard (AT)

(73) Assignee: OERLIKON TRADING AG, TRUBBACH, Trubbach (CH)

(21) Appl. No.: 13/978,237

(22) PCT Filed: Dec. 17, 2011
(86) PCT No.: PCT/EP2011/006393

§ 371 Date: Sep. 16, 2013

Related U.S. Application Data
(60) Provisional application No. 61/429,832, filed on Jan. 5, 2011.

(30) Foreign Application Priority Data
Sep. 6, 2011 (DE) 10 2011 112 434.2

(51) Int. Cl. B05D 3/14

(52) U.S. Cl. CPC B05D 3/14
USPC 427/532; 118/712

(57) ABSTRACT

The present invention relates to a method for effective spark detection during a process for treating workpieces with a vacuum treatment installation, For this purpose, in the case of a bias voltage applied to the workpieces, the discrepancy between the current flowing through the workpieces and a mean value is measured and, in the event of a threshold value being exceeded by this discrepancy, the process is stopped. According to the invention, the threshold value is made dependent on the magnitude of the bias voltage.

The present invention relates to a method for spark detection in coating installations. Spark in the present description denotes a breakthrough or breakdown voltage that can occur during plasma treatment in a vacuum chamber from a cathode to an anode. Such disruptive breakdowns are unwanted unless the process used happens to be arc evaporation. If such sparks increasingly hit the workpieces to be treated, this can result hi the workpieces being damaged.

According to the state of the art, the current flowing through the workpieces to be treated is measured. During breakdowns, short-circuits will occur, which result in a very fast current increase. For this reason, according to the state of the art, the current intensity is limited (I_{offset}). As soon as the current flowing through the workpieces exceeds the threshold value I_{offset}, switch-off is automatically initiated.

In practice, it is not workable to set an absolute threshold I_{offset}, since the flowing current depends on the respective charge. A mean current flow Iₘₑₐₙ is therefore measured over a specific time interval. If the current intensity suddenly increases within a given time At by more than a specified value, this is recorded as spark and the process is interrupted.

However, if ΔI is chosen too great, there will be no efficient switch-off and this can result in damages to the tool due to sparking. A negative voltage (negative bias) is often applied to the workpieces to be treated. In particular if low bias voltages are chosen, a ΔI that is too great will result in sparks not being recorded.

If however ΔI is chosen too small, the changes in conductance for example through poorly contacted tools can cause a current increase and thus result in an unwanted switching off of the coating process. This is in particular the case if, for the treatment of the workpieces, a comparatively high bias voltage is applied.

So far, the one skilled in the art had to chose for ΔI the kind of compromise which for low bias voltages did not lead to a sparking of the workpieces and which for high bias voltages did not cause an unwanted switch-off due to current variations that had nothing to do with sparks.

The primary object of the present invention is thus to provide a method by means of which the one skilled in the art does not need to make the compromise mentioned above.

According to the invention, the task is achieved by means of a method according to which ΔI is chosen depending on the currently applied bias voltage. According to the invention, Al is automatically coupled to the bias voltage in such a manner that at a low bias voltage a small ΔI is chosen and at high bias voltage a high ΔI is chosen.

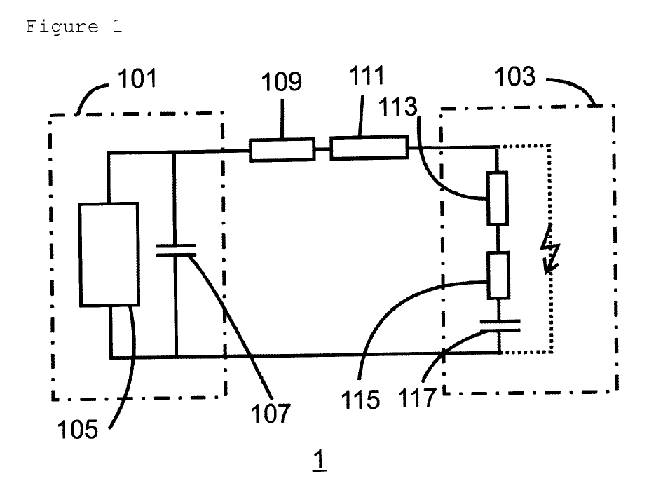

FIG. 1 shows an inventive coating facility 1 with a has generator 101 and a coating chamber 103. The bias generator 101 comprises a power unit 105. In the bias generator, its output capacity CG 1 07 is also shown. The input lead from the has generator 101 to the coating chamber 103 has an ohmic resistance RL and an inductance IL, in the coating facility, a plasma is generated, which leads to an ohmic plasma resistance RPL, a plasma inductance IPL and a plasma capacitance CPL. A lightning in FIG. 1 indicates in particular a short-circuit occurring after a disruptive breakdown.

In FIG. 1 it is possible to distinguish that at the capacitive output of the bias generator, because of the rapid processes during a spark, the power unit 101 can be disregarded. Therefore, in case of short-circuit, the flowing current is directly proportional to the voltage specified by the output capacitance.

In order now to determine which ΔI is to be chosen for which voltage, different threshold values for ΔI are set for a given bias voltage and the reasonable operating range is determined, For this bias voltage, the optimum threshold value is set for example at the center of the operating range. The bias voltage is subsequently changed, the operating range is determined for the newly set bias voltage and, with the center of the new operating range, the optimum threshold value is set for the new has voltage. The process is repeated a few more times so that the threshold value is determined depending on the bias voltage. The threshold value is then coupled, for example electronically, with the bias voltage according to this dependency. It is possible in this way to automatically determine the threshold value both for low voltages as well as for high voltages and this ensures reliable spark detection.

What is claimed is:

1. Method for treating a workpiece in a vacuum treatment facility wherein a negative, bias is applied to the workpiece and damage to the workpieces due to breakdowns during the treatment process in the vacuum treatment facility is avoided by interrupting the treatment process if the current flowing through the workpieces to be treated deviates positively from the previously measured mean current by more than a value ΔI, characterized in that the value ΔI is coupled in such a way to the negative bias that it increases monotonously, and within at least one range strictly monotonously, with the magnitude of the bias voltage.

2. Method according to claim 1, characterized in that ΔI increases linearly with the bias voltage.

3. Method according to claim 1, characterized in that to generate the bias voltage, a generator with capacitive output is used.

4. Vacuum treatment facility for treating workpieces in vacuum, comprising:
a vacuum chamber which can be evacuated,
a substrate holder in which workpieces to be treated can be placed,
a bias generator for applying a negative bias to the workpieces to be treated,
means for detecting the current flowing through the workpieces to be treated, means for averaging the detected current through the workpieces,
means for determining the deviation of the actual current through the workpieces from the mean current and comparison with an automatically adjustable maximum allowed deviation ΔI,
characterized in that
the vacuum treatment facility is designed in such a manner that the maximum allowed deviation ΔI is automatically set depending on the bias voltage applied to the workpieces.

5. Vacuum treatment facility according to claim 4, characterized in that in the facility, the maximum allowed deviation ΔI depends monotonously and preferably strictly monotonously from the magnitude of the bias voltage.

6. Vacuum treatment facility according to claim 5, characterized in that ΔI depends linearly on the bias voltage.
